(19) United States
(12) Patent Application Publication
(10) Pub. No.: US 2011/0255235 A1
(43) Pub. Date: Oct. 20, 2011

(54) Disk Drive Case

(76) Inventor: Deng-Hsi CHEN, Keelung (TW)

(21) Appl. No.: 12/197,263

(22) Filed: Aug. 24, 2008

(30) Foreign Application Priority Data
Jun. 3, 2008 (TW) 097209758

(51) Int. Cl. G06F 1/16

(52) U.S. Cl. 361/679.33

(57) ABSTRACT

A disk drive case is used to hold a disk drive and is then assembled into a corresponding slot in a computer case. The disk drive case provides a carrier to effectively protect the disk drive, allowing the disk drive to be quickly inserted into and pulled out of the slot of the computer case, such that the computer assembly operation can be faster and more convenient.

### BACKGROUND OF THE INVENTION

a) Field of the Invention

The present invention relates to a disk drive case which is used to hold a disk drive, and more particularly to a disk drive case which can be quickly inserted into or pulled out of a computer case, and by which the disk drive can be quickly positioned.

b) Description of the Prior Art

A removable disk case is first loaded with a disk drive (hard disk drive), and is then inserted into a device slot of a computer case. Usually, inside the device slot there will be provided with a corresponding connection port such that after the disk drive, along with the disk case, has been inserted, the disk drive will correspond to the position of the connection port, and connections of electricity and information are accomplished. In addition, the disk case is also provided with an ejection device, allowing the disk drive to separate with the connection port in the device slot only by an ejection action when the disk case is ejected. This disk case is a front-connection type that the device slot is usually at a front position of the computer case; whereas, the other type of removable disk case is a side-connection type and is applied inside the computer case. An insertion opening of the disk case is provided inside the computer case, and an opening end of the device slot is at a side of the computer case. This type of disk case is often used to assemble a built-in hard disk, and functions primarily to facilitate assembling the hard disk. The device slot fits primarily with a disk drive case, with a surface of the case being provided with a plurality of through-holes, such that after a disk drive has been placed on the surface of the case, screws are used to transfix the through-holes to lock the disk drive onto the surface of the case. Next, the entire disk drive case (including the disk drive) is inserted into the device slot, and is effectively fixed in the device slot. Although this kind of mechanism has been designed toward convenience, the fixing of the disk drive still requires locking elements (such as the screws) that the disk drive can be fixed effectively. Therefore, assistance with a tool is still required in disassembling and assembling. Accordingly, it is still inconvenient in a assembling, which still exists a significant space for improvement.

### SUMMARY OF THE INVENTION

Accordingly, the present invention is to provide a disk drive case which can be conveniently and quickly disassembled and assembled, so as to improve the conventional design.

To achieve the aforementioned object, a disk drive case of the present invention is formed with a plurality of first axial positioning devices to rapidly position the disk drive, and a second axial positioning device which can effectively clamp the disk drive such that the disk drive is fixed completely. Accordingly, when installing the disk drive, the disk drive can be quickly fixed by two mutually perpendicular axial positioning devices, thereby achieving the object of disassembling and assembling conveniently and quickly.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of the present invention.

FIG. 2 shows a schematic view of components before being assembled, in accordance with the present invention.

FIG. 3 shows a first schematic view of an implementation of the present invention.

FIG. 4 shows a second schematic view of an implementation of the present invention.

FIG. 5 shows a third schematic view of an implementation of the present invention.

FIG. 6 shows a fourth schematic view of an implementation of the present invention.

FIG. 7 shows a schematic view of another preferred embodiment of the present invention.

### DETAILED DESCRIPTION OF THE PREFERRED EMBODIMENTS

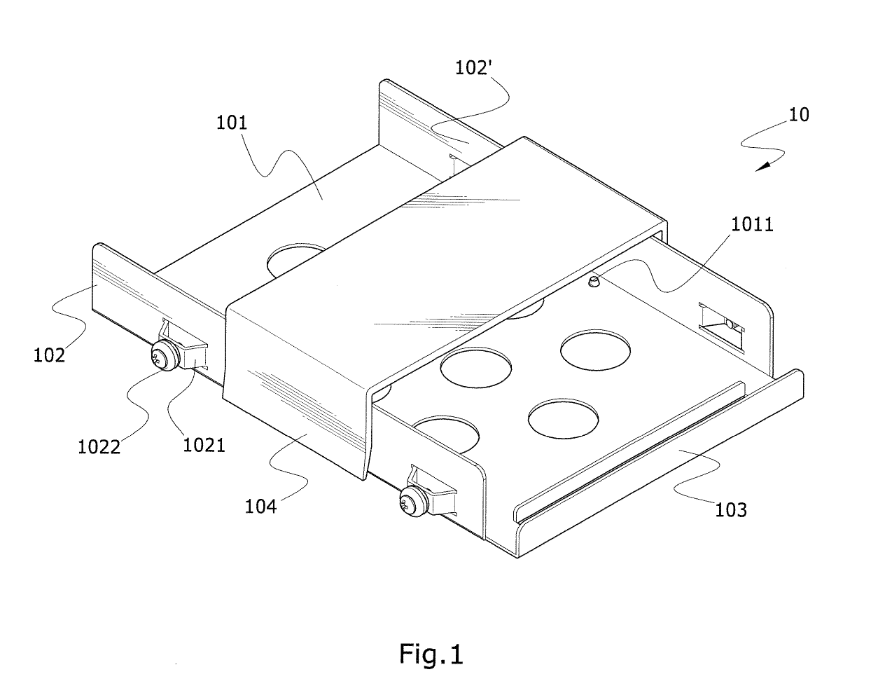

Referring to FIG. 1, it shows a three-dimensional view of the present invention, wherein a disk drive case 10 comprises primarily a disk assembly part 101, a surface of which is formed with a plurality of through-holes to increase a heat dissipation effect, and two sides of which are bended inward respectively to form a baffle wall 102, 102′, with surfaces of the two baffle walls 102, 102′ being protruded with a plurality of assembly parts 1021 that are provided respectively with a locking element 1022. In addition, an end of the disk assembly part 101 (the end between two baffle walls 102, 102′) is bended to form a pulling part 103, allowing an assembly person to exert force with fingers to facilitate disassembling or assembling. Furthermore, the surface of the disk assembly part 101 is protruded upward to form a plurality of first axial positioning devices 1011, and one baffle wall 102′ is loosely pivoted with a second axial positioning device 104 which is in a shape of a cover board and a movable end of which, after covering, can be locked at the baffle wall 102.

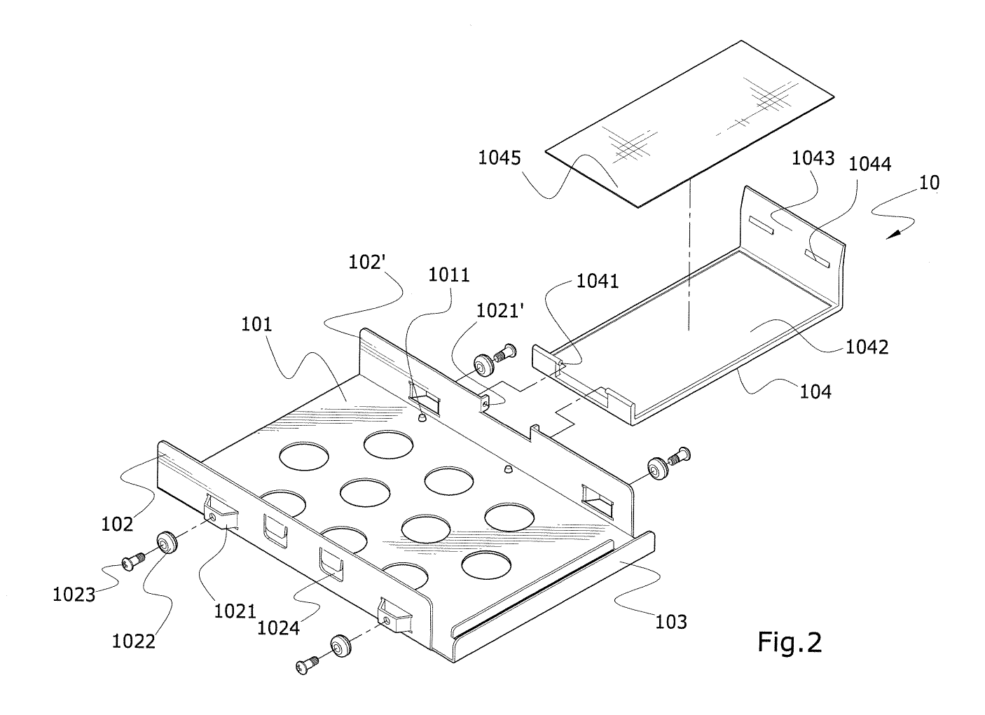

Referring to FIG. 2, it shows a schematic view of components before being assembled, in accordance with the present invention. The baffle wall 102′ of the disk drive case 10 is formed with a pivoting part 1021′ which forms a movable pivoting relation after being transfixed with a corresponding pivoting part 1041 formed at one end of the second axial positioning device 104. In other words, the second axial positioning device 104 can result in a corresponding open-close operation by the pivoting relation between the pivoting part 1021′ and the corresponding pivoting part 1041. On the other hand, the second axial positioning device 104 includes a suppressing part 1042 and an engaging part 1043; these two parts are roughly perpendicular to each other or their included angle is a little smaller than 90°. Moreover, in order to allow the engaging part 1043 to effectively latch, a surface of the engaging part 1043 can be formed with a plurality of engaging teeth 1044. As shown in the drawing again, on the baffle wall 102, at locations corresponding to the engaging teeth 1044, can be formed with engaging holes 1024 (or protruded ribs). Furthermore, to allow the second axial positioning device 104 to be tightly attached on a surface of the disk drive upon being fixed, a surface of the suppressing part 1042 is adhered with an elastic suppressing piece 1045. Therefore, when the suppressing part 1042 suppresses the surface of the disk drive, the suppressing part 1042 can be tightly attached to the disk drive by the elasticity of the suppressing piece 1045, allowing the disk drive to be effectively suppressed and fixed. As shown in the drawing once more, the locking element 1022 is made by a material having some elasticity and is fixed at the assembly part 1021 with a fixing element 1023. The primary function of this locking element 1022 is to lock the disk drive case 10 at a locking part (not shown in the drawing) which is formed in a device slot, after inserting into the device slot. On the other hand, the first axial positioning devices 1011 that are formed on the surface of the disk assembly part 101 collaborate primarily with screw holes formed on the disk drive to limit the disk drive to the first axial positioning devices 1011 by using these screw holes.

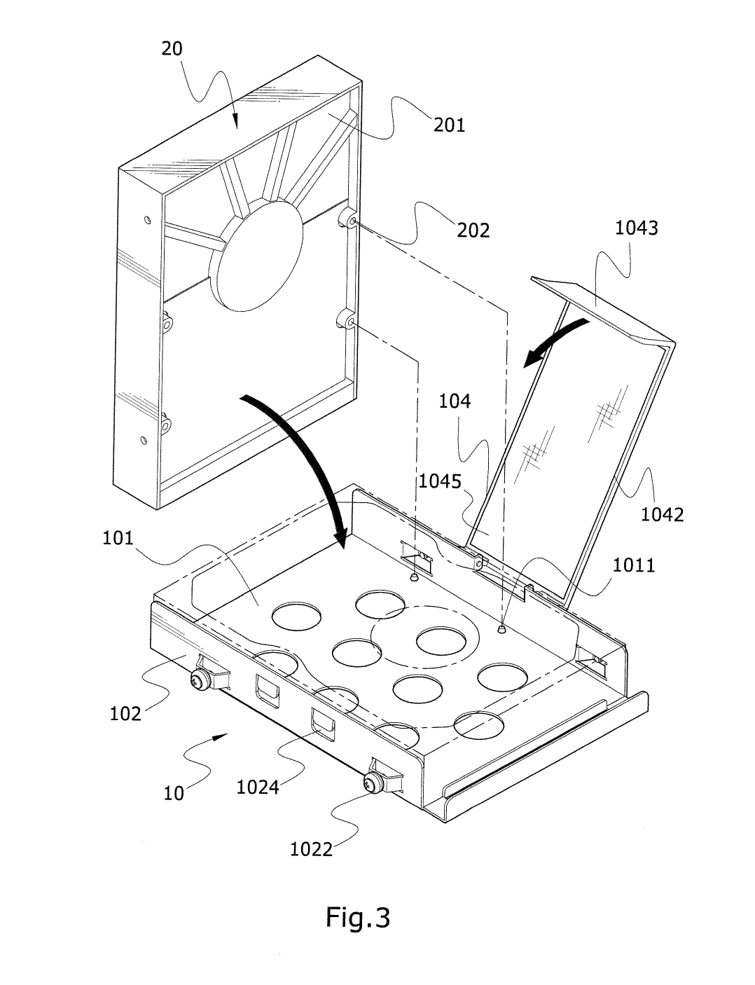

Referring to FIG. 3, it shows a first schematic view of an implementation of the present invention, wherein using the disk drive case 10 of the present invention, a disk drive 20 is quickly assembled in a computer. When implementing, a bottom part 201 of the disk drive 20 matches with the disk assembly part 101 of the disk drive case 10, and each screw hole 202 which is formed at the bottom part 201 matches with each first axial positioning device 1011 on the surface of the disk assembly part 101. Hence, the disk drive 20 can be positioned horizontally after being inserted into the disk assembly part 101, due to that as each screw hole 202 has been already inserted with each first axial positioning device 1011, the disk drive will not be able to displace along the horizontal direction. As shown in the drawing again, after placing the disk drive 20 (referring to a dotted line in the drawing), the second axial positioning device 104 is then covered, the engaging part 1043 at one end of the second axial positioning device 104 is engaged at the baffle wall 102 at the corresponding position, and the engaging teeth 1044 of the engaging part 1043 (referring to FIG. 2) are latched into the engaging holes 1024 of the baffle wall 102. After latching, the suppressing part 1042 of the second axial positioning device 104 can exactly suppress the disk drive 20 to accomplish a vertical positioning. Thereby, as the disk drive 20 has been completely positioned horizontally and vertically, it can be effectively assured that the disk drive 20 is fixed in the disk drive case 10. Moreover, as shown in the drawing, in order to fix the disk drive 20 more tightly, the suppressing part 1042 can be adhered with the suppressing piece 1045 having some elasticity, enabling the suppressing part 1042 to suppress the surface of the disk drive 20 more tightly.

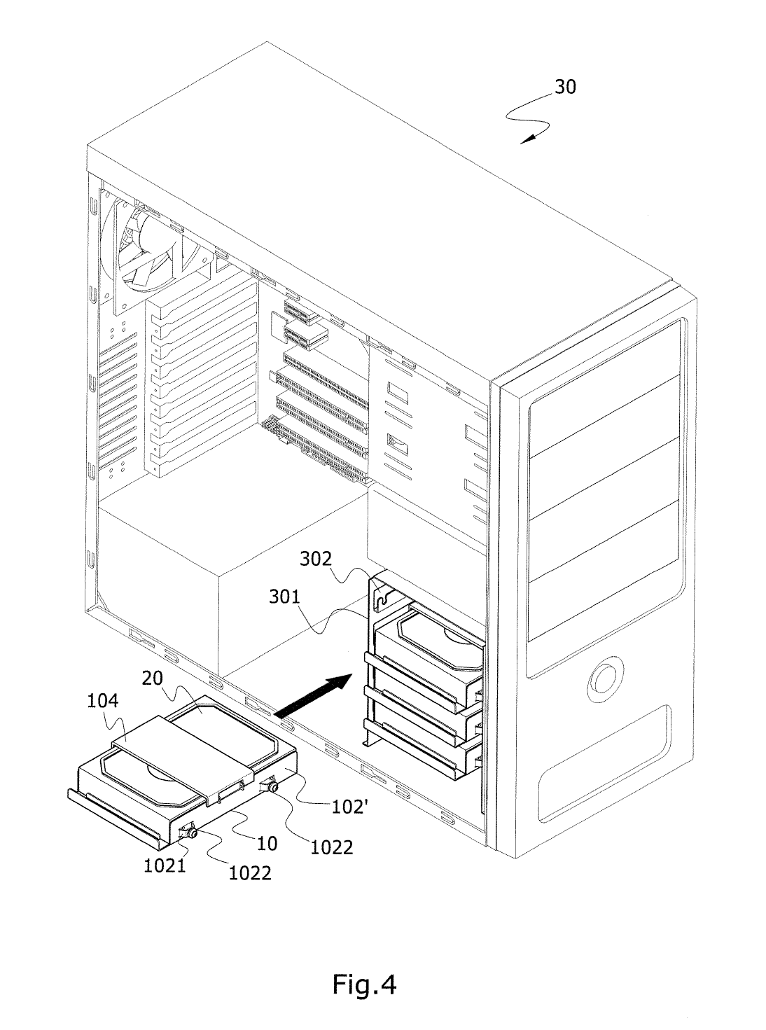

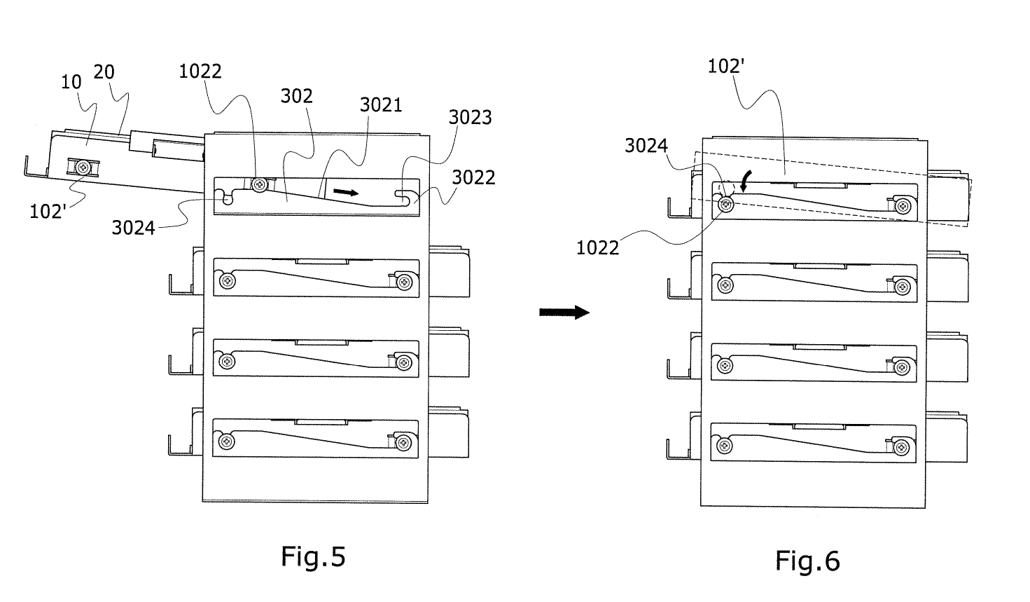

Referring to FIG. 4, it shows a second schematic view of an implementation of the present invention. Following FIG. 3, after the disk drive 20 has been entirely fixed in the disk drive case 10, the disk drive case 10 can be quickly inserted into a corresponding slot 301 of a computer host 30. As shown in FIG. 4, the slot 301 is located at a side of the computer host 30, and two sides of the slot 301 are formed with a corresponding slide rail 302. When the disk drive case 10 is to be placed into the slot 301, an end for insertion matches with the slide rails 302 and is then pushed in. Referring to FIG. 5, it shows a third schematic view of an implementation of the present invention. After one end of the disk drive case 10 has been placed into the slot 301, the locking elements 1022 at two sides of the disk drive 10 will correspond to the slide rails 302 and slide from the slide rails 302 to tail ends 3022 of the slide rails 302 along inclined chutes 3021. As the locking element 1022 is provided with some elasticity, it will be locked in a locking hole 3023 at the tail end 3022 of the slide rail 302. Referring to FIG. 6, it shows a fourth schematic view of an implementation of the present invention. Following FIG. 5, the entire disk drive case 10 is pressed down next, enabling the other locking element 1022 to be locked at the other locking hole 3024 at a front end of the slide rail 302, thereby accomplishing the quick assembly of the entire disk drive case 10 and the disk drive 20. On the other hand, upon disassembling, the front end of the disk drive case 10 is pushed upward first, and then the entire disk drive case 10 is pulled out, thereby accomplishing the disassembly operation.

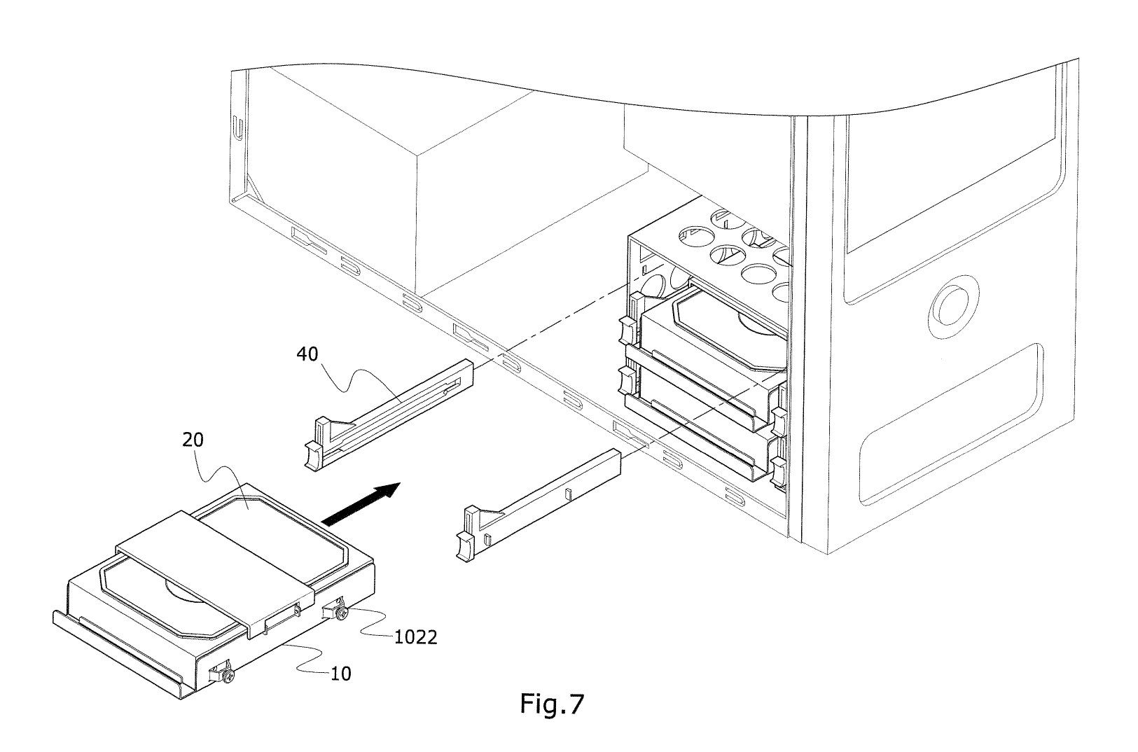

Referring to FIG. 7, it shows a schematic view of another preferred embodiment of the present invention, wherein the locking element 1022 can also match with another kind of slide rail with an inner slot. For example, as shown in the drawing, a slide rail 40 is a slide rail with an inner slot. The locking element 1022 can be pushed into the slide rail 40, and the remaining operations are the same as those disclosed in FIG. 4 and FIG. 6.

Accordingly, the disk drive case 10 of the present invention primarily provides the first axial positioning devices 1011 to fix the disk drive 20 horizontally, and the second axial positioning device 104 (as shown in FIG. 1) to fix the disk drive 20 vertically. Thereby, the disk drive 20 can be fixed quickly and effectively, and can be quickly inserted into or pulled out of the slot in the computer host by using the plural locking elements 1022 at the sides of the disk drive case 10. Accordingly, after implementing the disk drive case of the present invention, the object of providing a disk drive case that can be disassembled and assembled conveniently and quickly is actually achieved.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A disk drive case which is used to hold a disk drive, enabling the disk drive to be disassembled from or assembled into a device slot in a computer case quickly, comprising:
a disk assembly part, two sides of which are bended inward respectively with a baffle wall, with surfaces of the two baffle walls being protruded to form a plurality of assembly parts that are provided with a locking element respectively, and one baffle wall being formed with a pivoting part;
a plurality of first axial positioning devices which are protruded and formed on a surface of the disk assembly part; and
a second axial positioning device, which is provided with a suppressing part, with an end of the suppressing part being formed with a corresponding pivoting part to assemble the pivoting part of one baffle wall of the disk assembly part, the other end of the suppressing part being formed with an engaging part to be locked on the other baffle wall at the corresponding location.

2. The disk drive case according to claim 1, wherein an end of the disk assembly part is formed with a pulling part.

3. The disk drive case according to claim 1, wherein the suppressing part of the second axial positioning device is adhered with a suppressing piece with some elasticity.

4. The disk drive case according to claim 1, wherein a surface of the engaging part of the second axial positioning device is formed with a plurality of engaging teeth.

5. The disk drive case according to claim 4, wherein on the baffle wall, at locations corresponding to the engaging teeth, are formed with corresponding engaging holes.

6. The disk drive case according to claim 4, wherein on the baffle wall, at locations corresponding to the engaging teeth, are formed with corresponding ribs.

7. The disk drive case according to claim 1, wherein an included angle of roughly 90° is formed between the suppressing part and the engaging part of the second axial positioning device.

8. The disk drive case according to claim 1, wherein an included angle of a little smaller than 90° is formed between the suppressing part and the engaging part of the second axial positioning device.

9. The disk drive case according to claim 1, wherein the locking element is fixed at the assembly part with a fixing element.

10. The disk drive case according to claim 1, wherein the disk assembly part is formed with a plurality of through-holes to increase a heat dissipation effect.
